(19) United States
(12) Patent Application Publication
(10) Pub. No.: US 2022/0076573 A1
(43) Pub. Date: Mar. 10, 2022

(54) ELECTRICAL CABINETS AND METHODS USING SAME

(71) Applicant: LOGISIG INC., Fossambault-sur-le-Lac (CA)

(72) Inventor: Serge FOURNIER, Fossambault-sur-le-lac (CA)

(21) Appl. No.: 17/417,128

(22) PCT Filed: Dec. 20, 2019
(86) PCT No.: PCT/CA2019/051874

§ 371 Date: Jun. 22, 2021

Related U.S. Application Data
(60) Provisional application No. 62/791,240, filed on Jan. 11, 2019.

(51) Int. Cl. G08G 1/095; H01R 12/72; H05K 5/02

(52) U.S. Cl. CPC G08G 1/095; H05K 5/02; H01R 12/72

(57) ABSTRACT

There is described an electrical cabinet for a traffic signaling system. The electrical cabinet generally having: a housing defining a cavity; an electrical interface in said cavity, the electrical interface having a port being connectable to the traffic signaling system and having an edge connector being connected to said port; and a traffic light controller having a corresponding edge connector being connectively received in said edge connector of said electrical interface and being maintained in position therein once received, said traffic light controller being configured for controlling the traffic signaling system via said electrical interface, said controlling including receiving, via said port, a plurality of input signals from the traffic signaling system and transmitting, via said port, a plurality of output signals to the traffic signaling system.

### FIELD

The improvements generally relate to the field of electronic cabinets and more particularly electronic cabinets for traffic signaling systems.

### BACKGROUND

Traffic signaling systems generally include one or more traffic lights positioned at road intersections, pedestrian crossings and other locations susceptible to experience traffic flows. The traffic lights are generally controlled via a traffic light controller which is connected to the traffic lights, so as to ensure as smooth and safe traffic as possible for vehicles, cyclists and/or pedestrians.

In practice, the traffic signaling system typically has input conductors and output conductors which may wiredly run underground towards a common location they are connected with the traffic light controller. Understandably, it was found convenient to connect the input and output conductors of the traffic signaling system to the traffic light controller within an electrical cabinet so as to suitably protect these connections.

With existing technologies, it is generally known to connect the input and output conductors to an electrical interface inside the electrical cabinet, and to connect this electrical interface to the traffic light controller, and other electronic components, via wire harnesses thereinside. Although existing electrical cabinets are satisfactory to a certain degree, there remains room for improvement, especially in reducing the risks of misconnections generally associated to such wire harnesses. There remains room for improvement also in terms of alleviating the computational requirements imparted on the traffic light controller during use.

### SUMMARY

In an aspect, there is described an electrical cabinet which can at least alleviate some of the above-mentioned drawbacks. It was found that, in at least some situations, the typical quantity of wire harnesses found in existing electrical cabinets could impede the efficiency at which maintenance could be performed within such electrical cabinets. Moreover, it was found that using such wire harnesses could increase the risks of misconnections between the input and output conductors and the traffic lighting controller.

Having regards to this aspect, there is described an electrical cabinet for a traffic signaling system. The electrical cabinet has a housing defining a cavity, an electrical interface in the cavity and a port being connectable to the traffic signaling system via said input and output conductors, for instance. The electrical interface has an edge connector being connected to the port and being configured for connectively receiving a corresponding edge connector of a traffic light controller. When the traffic light controller is so-received, the traffic light controller can be maintained in position and be connected to the traffic signaling system, e.g., via the electrical interface, for controlling the traffic signaling system. As will be described, the traffic light controller can control the traffic signaling system by receiving, via the port, a plurality of input signals from the traffic signaling system and by transmitting, also via the port, a plurality of output signals to the traffic signaling system.

In accordance with a first aspect of the present disclosure, there is provided an electrical cabinet for a traffic signaling system, the electrical cabinet comprising: a housing defining a cavity; an electrical interface in said cavity, the electrical interface having a port being connectable to the traffic signaling system and having an edge connector being connected to said port; and a traffic light controller having a corresponding edge connector being connectively received in said edge connector of said electrical interface and being maintained in position therein once received, said traffic light controller being configured for controlling the traffic signaling system via said electrical interface, said controlling including receiving, via said port, a plurality of input signals from the traffic signaling system and transmitting, via said port, a plurality of output signals to the traffic signaling system.

Further in accordance with the first aspect of the present disclosure, said edge connector of said traffic light controller can for example be slidably received in said edge connector of said electrical interface.

Still further in accordance with the first aspect of the present disclosure, said electrical interface can for example have two spaced-apart parallel runners extending perpendicularly from said electrical interface and being adjacent said edge connector of said electrical interface, the traffic light controller being provided in the form of a plug-in drawer being slidably received between said runners.

Still further in accordance with the first aspect of the present disclosure, the electrical interface can for example have a plurality of input conductors and a plurality of output conductors extending between said port and said edge connector of said electrical interface.

Still further in accordance with the first aspect of the present disclosure, said input conductors and said output conductors can for example extend at least partially within a panel body of said electrical interface.

Still further in accordance with the first aspect of the present disclosure, said housing can for example have an opening for sealingly receiving a portion of an input signal cable and a portion of an output signal cable.

Still further in accordance with the first aspect of the present disclosure, the electrical interface can for example have a plurality of other edge connectors being configured to connectively receive a plurality of other electrical components each having corresponding edge connectors.

Still further in accordance with the first aspect of the present disclosure, said traffic light controller can for example extend parallel to a vertical plane of said electrical cabinet when in position.

Still further in accordance with the first aspect of the present disclosure, the edge connector of the electrical interface can for example be a female edge connector and the edge connector of the traffic light controller is a male edge connector.

Still further in accordance with the first aspect of the present disclosure, said male edge connector can for example include an edge of a printed circuit board and conductive traces leading up to said edge.

Still further in accordance with the first aspect of the present disclosure, the electrical cabinet can for example comprise an auxiliary controller being housed in the cavity and being connected to and computationally independent from said traffic light controller, the auxiliary controller being configured for performing auxiliary functions which do not affect said controlling.

Still further in accordance with the first aspect of the present disclosure, said auxiliary functions can for example comprise at least one step of a group consisting of: performing a diagnostic test on said traffic light controller; collecting data relative to said traffic light controller; displaying data on a monitor; communicating data to a remote system; and storing data on a memory of said auxiliary controller.

In accordance with a second aspect of the present disclosure, there is provided a method for controlling a traffic signaling system using a traffic light controller via an electrical cabinet, the electrical cabinet having a housing defining a cavity inside which lies an electrical interface, the method comprising: connecting the traffic signaling system to a port of said electrical interface; and connecting an edge connector of the traffic light controller to a corresponding edge connector of the electrical interface, thereby maintaining said traffic light controller maintained in position once received; said traffic light controller controlling said traffic signaling system, said controlling including receiving, via said port, a plurality of input signals from the traffic signaling system and transmitting, via said port, a plurality of output signals to the traffic signaling system.

Further in accordance with the second aspect of the present disclosure, wherein said connecting can for example include slidably connecting said edge connector of said traffic light controller to said edge connector of said electrical interface.

Still further in accordance with the second aspect of the present disclosure, said connecting can for example include connecting an edge of said traffic light controller to said edge connector of the electrical interface.

Still further in accordance with the second aspect of the present disclosure, said electrical interface can for example have an edge connector and said auxiliary controller has a corresponding edge connector, the method further comprising connecting the auxiliary controller to said electrical interface said edge connectors, said auxiliary controller being configured for performing auxiliary functions which do not affect said controlling of said traffic light controller.

Still further in accordance with the second aspect of the present disclosure, said auxiliary functions can for example comprise at least one step of a group consisting of: performing a diagnostic test on said traffic light controller; collecting data relative to said traffic light controller; displaying data on a monitor; communicating data to a remote system; and storing data on a memory of said auxiliary controller.

In another aspect, there is described an electrical cabinet which can at least alleviate some of the above-mentioned drawbacks. More specifically, it was found that, in existing electrical cabinets, the traffic light controller is generally used to control the traffic signaling system as well as to perform auxiliary tasks which are not critical to the direct control of the traffic signaling system. Accordingly, in at least some situations, an unduly amount of computational power of the traffic light controller may be requisitioned by the auxiliary tasks, which can eventually lead to delays and/or failures in the control of the traffic signaling system. The inventor found that providing an additional, auxiliary controller which is connected to but computationally independent from the traffic light controller could reduce such drawbacks. In such an aspect, the auxiliary controller is dedicated to perform these auxiliary tasks which do not affect the controlling of the traffic signaling system by the traffic light controller, and thus alleviate the computation power imparted on the traffic light controller itself.

Regarding this aspect, there is described an electrical cabinet for a traffic signaling system. The electrical cabinet has a housing defining a cavity, and a traffic light controller inside the cavity and connected to the traffic signaling system for controlling thereof. In addition, an auxiliary controller is provided to perform auxiliary functions which do not affect the controlling tasks performed by the traffic light controller. To reduce the computation power requirements on the traffic light controller, it was found convenient for the auxiliary controller to be connected to and computationally independent from the traffic light controller.

In accordance with a third aspect of the present disclosure, there is provided an electrical cabinet for a traffic signaling system, the electrical cabinet comprising: a housing defining a cavity; a traffic light controller being housed in the cavity and being connectable to the traffic signaling system, said traffic light controller being configured for controlling said traffic signaling system, said controlling including receiving a plurality of input signals from the traffic signaling system and transmitting plurality of output signals to the traffic signaling system; and an auxiliary controller being housed in the cavity and being connected to and computationally independent from said traffic light controller, the auxiliary controller being configured for performing auxiliary functions which do not affect said controlling.

Further in accordance with the third aspect of the present disclosure, said receiving can for example comprise at least one step of a group consisting of: receiving an input signal from one or more sensors of said traffic signaling system; receiving an input signal from one or more pedestrian buttons of said traffic signaling system; and receiving an input signal from one or more pre-emption modules in communication with said traffic signaling system.

Still further in accordance with the third aspect of the present disclosure, wherein said transmitting can for example comprise at least one step of a group consisting of: transmitting an output signal to one or more traffic lights of said traffic signaling system; transmitting an output signal to one or more pedestrian crossing lights of said traffic signaling system; and transmitting an output signal to one or more prepare-to-stop panels of said traffic signaling system.

Still further in accordance with the third aspect of the present disclosure, said auxiliary functions can for example comprise at least one step of a group consisting of: performing a diagnostic test on said traffic light controller; collecting data relative to said traffic light controller; displaying data on a monitor; communicating data to a remote system; and storing data on a memory of said auxiliary controller.

Still further in accordance with the third aspect of the present disclosure, wherein the traffic light controller can for example include one or more sister circuits connected to one another.

Still further in accordance with the third aspect of the present disclosure, said auxiliary controller can for example include a memory for storing data thereon.

Still further in accordance with the third aspect of the present disclosure, said traffic light controller and said auxiliary controller can for example be provided in the form of separate printed circuit boards.

Still further in accordance with the third aspect of the present disclosure, said traffic light controller and said auxiliary controller can for example extend parallel to a vertical plane of said electrical cabinet.

Still further in accordance with the third aspect of the present disclosure, the electrical cabinet can for example comprise an electrical interface via which said traffic light controller and said auxiliary controller are connected to one another.

Still further in accordance with the third aspect of the present disclosure, said traffic light controller can for example have an edge connector being connectively received in a corresponding edge connector of said electrical interface and being maintained in position therein once received.

Still further in accordance with the third aspect of the present disclosure, said edge connector of said traffic light controller can for example be slidably received in said edge connector of said electrical interface.

In accordance with a fourth aspect of the present disclosure, there is provided a method for operating a traffic signaling system, the method comprising: controlling said traffic signaling system using a traffic light controller being connected to the traffic signaling system, said controlling including receiving a plurality of input signals from the traffic signaling system and transmitting plurality of output signals to the traffic signaling system; and performing auxiliary functions pertaining to said traffic signaling system using an auxiliary controller being connected to and computationally independent from said traffic light controller, the auxiliary functions being prevented from affecting said controlling.

Further in accordance with the fourth aspect of the present disclosure, said receiving can for example comprise at least one step of a group consisting of: receiving an input signal from one or more sensors of said traffic signaling system; receiving an input signal from one or more pedestrian buttons of said traffic signaling system; and receiving an input signal from one or more pre-emption modules in communication with said traffic signaling system.

Still further in accordance with the fourth aspect of the present disclosure, said transmitting can for example comprise at least one step of a group consisting of: transmitting an output signal to one or more traffic lights of said traffic signaling system; transmitting an output signal to one or more pedestrian crossing lights of said traffic signaling system; and transmitting an output signal to one or more prepare-to-stop panels of said traffic signaling system.

Still further in accordance with the fourth aspect of the present disclosure, said auxiliary functions can for example comprise at least one step of a group consisting of: performing a diagnostic test on said traffic light controller; collecting data relative to said traffic light controller; displaying data on a monitor; communicating data to a remote system; and storing data on a memory of said auxiliary controller.

In accordance with a fifth aspect of the present disclosure, there is provided an electrical cabinet for enclosing electrical components, the electrical cabinet comprising: a housing defining a cavity; an electrical interface in said cavity and having a plurality of female edge connectors, the electrical interface having a plurality of conductors connecting the plurality of female edge connectors to one another; a plurality of electrical components each having male edge connectors being connectively received in a corresponding one of the plurality of female edge connectors and maintained in position therein once received, thereby allowing the electrical components to interact with one another.

Many further features and combinations thereof concerning the present improvements will appear to those skilled in the art following a reading of the instant disclosure.

### DESCRIPTION OF THE FIGURES

In the figures,

FIG. 1 is a schematic view of an example of a traffic signaling system, shown with an electrical cabinet having a traffic light controller therein, in accordance with one or more embodiments;

FIG. 1A is a sectional view of the electrical cabinet of FIG. 1, taken along line 1A-1A of FIG. 1;

FIG. 2 is a schematic view of an example of a computing device of the traffic light controller of FIG. 1, in accordance with one or more embodiments;

FIG. 3 is a schematic view of an example of an electrical cabinet, with a traffic light controller and an auxiliary controller, in accordance with one or more embodiments;

FIG. 4 is an oblique view of an example of the traffic light controller of FIG. 3, shown with two sister circuits connected to one another, in accordance with one or more embodiments;

FIG. 4A is a block diagram representing serial communications occurring inside the electrical cabinet of FIG. 3, in accordance with one or more embodiments;

FIG. 5 is an oblique view of the electrical cabinet of FIG. 3, in accordance with one or more embodiments;

FIG. 5A is an enlarged view of the electrical cabinet of FIG. 5, showing the traffic light controller being connected to an electrical interface via a corresponding pair of edge connectors, in accordance with one or more embodiments; and

FIGS. 6A-B is a block diagram showing example components and connections housed within the electrical cabinet of FIG. 5.

### DETAILED DESCRIPTION

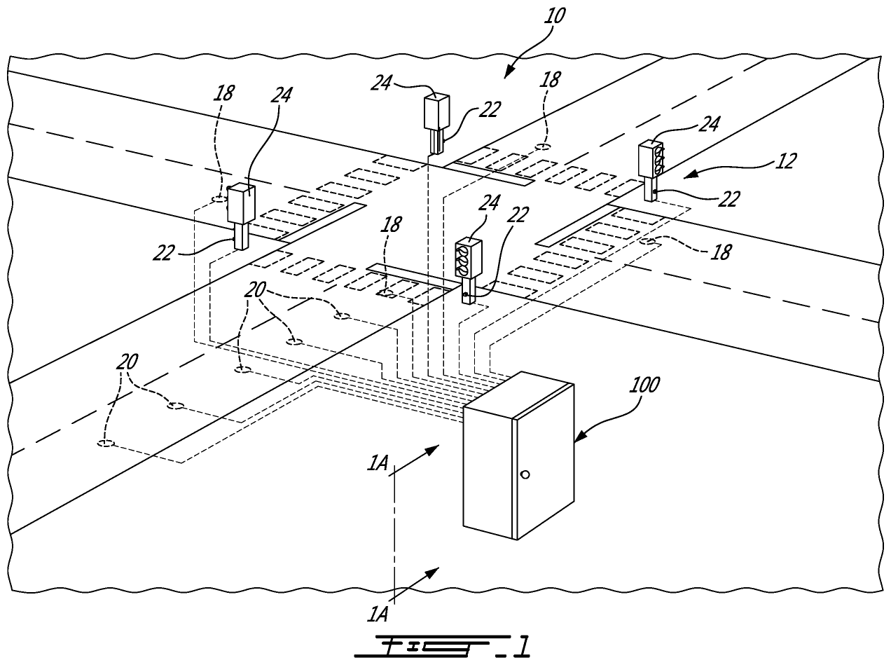

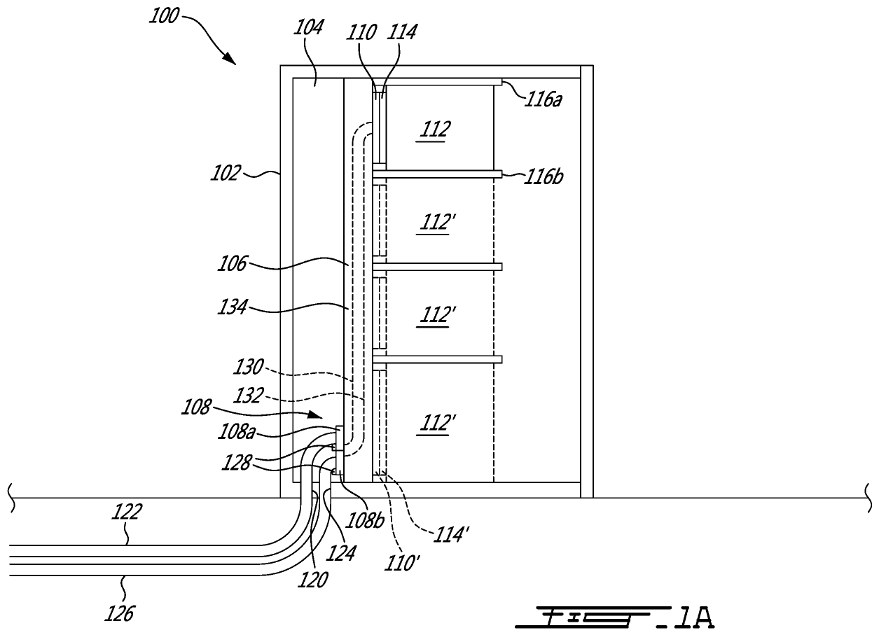

FIG. 1 shows an example of an electrical cabinet 100 for a traffic lighting system 10 which is located near a road intersection 12. In this specific example, the traffic signaling system 10 is controllable via a plurality of input signals, which may be received from the traffic signaling system 10, and via a plurality of output signals, which may be transmitted towards the traffic signaling system 10.

The input signals may be received from input devices. Examples of input devices can include, but are not limited to, vehicle sensor(s) 18 such as camera(s) and/or underground sensor(s), queue sensor(s) 20, pedestrian crossing button(s) 22, pre-emption module(s) and/or any other input device from which input signals can be received to control the traffic signaling system 10. The output signals may be transmitted to output devices. Examples of output devices can include traffic light(s) 24, pedestrian crossing light(s), prepare-to-stop panels and/or any other output device towards which an output signal can be transmitted to control the traffic signaling system 10.

As can be understood, the pre-emption modules referred to above can include a railroad pre-emption module which is configured to modify the traffic signaling system with the approach of a train at the road intersection. Bus and priority transport pre-emption modules can also be provided so as to modify the traffic signaling system to coincide with the arrival of a bus or tram along a busway, bus lane, tramway or any other priority transportation means. There can also be emergency vehicles pre-emption modules which modify the traffic signaling system in a way that such emergency vehicles experience only green lights, as light which may turn only amber and then red when fire trucks, ambulances, or other emergency vehicles or the like are exiting the station in direction to an emergency.

FIG. 1A shows a sectional view of the electrical cabinet 100 of FIG. 1. As shown, the electrical cabinet 100 has a housing 102 defining a cavity 104, and an electrical interface 106 housed within the cavity 104. The electrical interface 106 has a port 108 being connected to the traffic signaling system 10 during use, and an edge connector 110 being connected to the port 108. As depicted, the electrical interface 106 has a traffic light controller 112 with an edge connector 114 which is connectively received in the edge connector 110 of the electrical interface 106, thereby maintaining the traffic light controller 112 in position once received. As can be understood, the traffic light controller 112 is configured for controlling the traffic signaling system. More specifically, the traffic light controller 112 can be configured to receive, via the port 108, the input signals from the traffic signaling system 10 and for transmitting, also via the port 108, the output signals to the traffic signaling system 10.

In this embodiment, the edge connector 110 is a female edge connector (hereinafter “female edge connector 110”) and the edge connector 114 is a male edge connector (hereinafter “male edge connector 114”). Accordingly, the male edge connector 114 of the traffic light controller 112 is connectively received in the female edge connector 110 of the electrical interface 106. In this example, the edge connectors 110 and 114 are provided in the form of EDAC® edge connectors. However, any other suitable edge connectors could have alternatively been used including, but not limited to, card edge connectors and the like.

For instance, in embodiments where the traffic light controller 112 is provided in the form of a printed circuit board (PCB), the male edge connector 114 of the traffic light controller 112 can be a card edge connector. In such embodiments, the male edge connector 114 includes an edge of the PCB and conductive traces leading up to that edge.

In this example, the edge connector 114 is slidably received in the edge connector 110. For instance, the electrical interface 106 has two spaced-apart parallel runners 116a and 116b extending perpendicularly from the electrical interface 106. As illustrated, each runner 116a, 116b is mounted adjacent to the edge connector 110 of the electrical interface 106. Accordingly, the traffic light controller 112 is correspondingly provided in the form of a plug-in drawer which is slidably received between the two spaced-apart parallel runners 116a and 116b, for guiding the connection between the edge connectors 110 and 114.

In some other embodiments, the electrical interface 106 can have fewer than two or more than two runners protruding from the electrical interface 106 and along which the traffic light controller 112 can be slidably received. In further embodiments, the housing 102 can have one or more tablets on which the traffic light controller 112 may slide, or rest upon, prior to or upon connection between the edge connectors 110 and 114.

As can be understood, the port 108 and the traffic signaling system 10 can be connected to the port 108 via a wired connection, a wireless connection, or a combination of both. More specifically, in this example, the housing 102 has an input opening 120 that sealingly receives an input cable 122 carrying input signals and an output opening 124 that sealingly receives an output cable 126 carrying output signals. As such, in this example, the port 108 includes an input port 108a and an output port 108b which are each connected to a respective input cable 122 and output cable 126 via corresponding connectors 128. In alternate embodiments, the housing 102 can have a single opening sealingly receiving both the input and output cables 122 and 126. Alternately, the input and output signals can be carried via a single cable in some other embodiments.

As illustrated, the electrical interface 106 has input conductors 130 extending between the input port 108a and the edge connector 110 of the electrical interface 106. Similarly, the electrical interface 106 has output conductors 132 extending between the output port 108b and the edge connector 110 of the electrical interface 106. Accordingly, in this embodiment, the traffic light controller 112 is connected to the traffic signaling system 10 via cables 122 and 124, conductors 130, 132, ports 108a and 108b, and edge connectors 110 and 114. As shown, the input conductors 130 and the output conductors 132 can at least partially extend within, or run along, a panel body of the electrical interface 106.

In this example, the traffic light controller 112 is provided in the form of one or more analog circuit boards which can have card edge connectors suited for electrical connection to the edge connector 110 of the electrical interface 106.

It was found convenient to provide the electrical interface 106 in the form of a panel body 134 which extends vertically within the cavity 104 of the housing 102. More specifically, the panel body 134 can be abutted to or spaced apart from an interior surface of one of the lateral walls of the housing 102. The panel body 134 can face a door of the electrical cabinet 100.

In the illustrated embodiment, the electrical interface 106 has one or more other edge connectors 110′ which are configured to connectively receive one or more other electrical components 112′ via corresponding edge connectors 114′. Examples of such other electrical components can include, but are not limited to, a main power supply, a secondary power supply, communication port(s), a graphical user interface, and the like. In this way, the connection between the other electrical components 112′ and the electrical interface 106 can be facilitated as well, thereby further reducing the amount of wire harnesses required inside the electrical cabinet 100.

In such embodiments, the edge connectors 110 and 110′ of the electrical interface 106 can be positioned in a vertically extending array so that the traffic light controller 112 and the electrical components 112′ can lie parallel to a vertical plane of the electrical cabinet 100 when connected thereto, laterally- or vertically-stacked relative to one another.

Referring back to FIG. 1, the traffic lighting controller 112 is configured to control the traffic signaling system 10 by receiving input signals from the input devices of the traffic signaling system 10 and/or by transmitting output signals to the output devices of the traffic signaling system 10. For instance, input signals can be received from the vehicle sensor(s) 18, the queue sensor(s) 20, the pedestrian crossing button(s) 22, pre-emption module(s), and/or any other device which can receive an input signal for controlling the traffic signaling system 10. Output signals can be transmitted to the traffic light(s) 24, to the pedestrian crossing light(s), to the prepare-to-stop panel(s) and/or any other device to which can be transmitted an output signal for controlling the traffic signaling system 10.

In some embodiments, the traffic lighting controller 112 may also be configured to perform auxiliary functions, which do not directly relate to the control of the traffic signaling system 10. Examples of such auxiliary functions can include, but are not limited to, performing a diagnostic test on the traffic light controller 112, collecting data relative to the traffic light controller 112, displaying data on a monitor inside the electrical cabinet 100, receiving data from one or more remote sensors external to the traffic signaling system 10 such as from autonomous vehicles, communicating data to one or more remote systems, storing data on one or more memories and similar data processing steps.

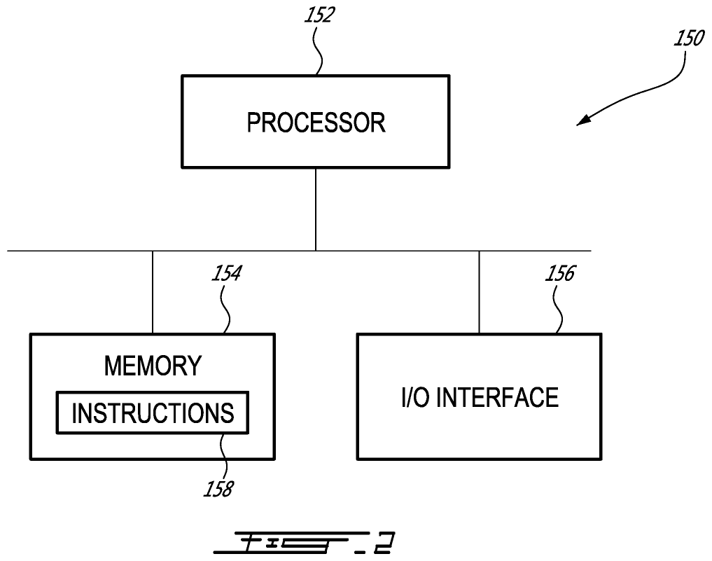

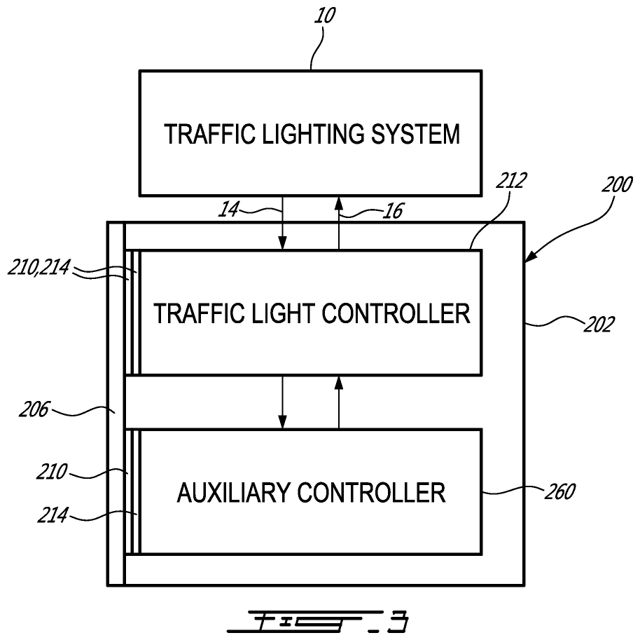

The traffic light controller 112 can be provided as a combination of hardware and software components. The hardware components can be implemented in the form of a computing device 150, an example of which is described with reference to FIG. 2. Moreover, the software components of the traffic light controller 112 can be implemented in the form of a software application.

Referring to FIG. 2, the computing device 150 can have a processor 152, a memory 154, and I/O interface 156. Instructions 158 for controlling the traffic signaling system 10 can be stored on the memory 154 and accessible by the processor 152. For instance, such instructions may be based on predetermined sequences, durations, traffic hours or traffic days as would be apparent for the skilled reader.

The processor 152 can be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 154 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

In this embodiment, each I/O interface 156 enables the computing device 150 to interconnect with the input devices and with the output devices of the traffic signaling system 10.

In this embodiment, each I/O interface 156 enables the traffic light controller 112 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The computing device 150 is meant to be examples only. Other suitable embodiments of the traffic light controller 112 can also be provided, as it will be apparent to the skilled reader.

For instance, in a further aspect, the inventor found that electrical cabinets, such as the electrical cabinet 100, in which the traffic light controller 112 was used both for controlling the traffic signaling system 10 and for performing such auxiliary tasks could drain a significant computational power of the traffic light controller 112, which could then lead to delays and/or failures in the control of the traffic signaling system 10. There was thus a need in the industry for limiting such delays and/or failures in the control of the traffic signaling system 10.

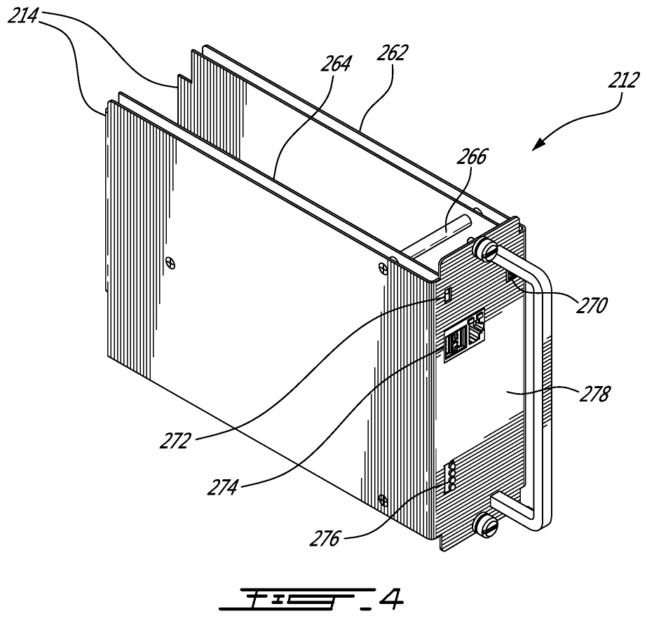

As shown in FIG. 3, it was found convenient to provide an electrical cabinet 200 having a housing 202 defining a cavity 204 inside which are provided a traffic light controller 212 along with an auxiliary controller 260. More specifically, although the auxiliary controller 260 can be connected to the traffic light controller 212, the auxiliary controller 260 is computationally independent from the traffic light controller 212. In other words, when the auxiliary controller 260 performs one or more of the auxiliary tasks, the traffic light controller is not or almost not computationally solicited. As such, the auxiliary controller 260 is configured for performing auxiliary functions, such as the ones described above, which do not affect the controlling of the traffic signaling system 10 by the traffic light controller 212. In this way, the traffic light controller 212 can be used solely for tasks having regards to controlling the traffic signaling system 10, and not for non-critical, auxiliary tasks.

Still in these embodiments, it was found preferable to provide the traffic light controller 212 and the auxiliary controller 260 in the form of separate printed circuit boards, which are nonetheless connected to one another. For instance, both the traffic light controller 212 and the auxiliary controller 260 can be connected to an electrical interface 206 via corresponding edge connectors 210 and 214. Accordingly, the traffic light controller 212 and the auxiliary controller 260 can be connected to one another via the electrical interface 206. The illustrated example shows that both the light controller 212 and the auxiliary controller 260 extend parallel to a vertical plane of the electrical cabinet 200.

Both the traffic light controller 212 and the auxiliary controller 260 can have a computing device such as the one described with reference to FIG. 2. Whereas the traffic light controller 212 can be provided in the form of a combination of hardware components customized to fit relative to one another, the auxiliary controller 260 can be an off-the-shelf computer running an operating system such as Windows®, for instance.

As such, in embodiments where the input signals and the output signals of the traffic signaling system 10 are analog, the traffic light controller 212 can be configured so that it includes one or more analog circuits. In such embodiments, the auxiliary controller 260 can be configured to include one or more digital circuits to perform the auxiliary tasks which are generally more numerical and/or digital in nature.

In some embodiments, the traffic light controller 212 can control the traffic signaling system 10 by receiving one or more input signals from one or more of the input devices of the traffic signaling system 10. For instance, the traffic light controller 212 may receive an input signal from one or more sensors of the traffic signaling system 10, an input signal from one or more pedestrian buttons of the traffic signaling system 10, or an input signal from one or more pre-emption modules in communication with the traffic signaling system 10. Other types of input signals can also be received and managed by the traffic light controller 212, depending on the embodiment.

More specifically, in some other embodiments, the traffic light controller 212 can control the traffic signaling system 10 by transmitting one or more output signals to one or more output devices of the traffic signaling system 10. For example, the traffic light controller 212 can transmit an output signal to one or more traffic lights of the traffic signaling system 10, an output signal to one or more pedestrian crossing lights of the traffic signaling system 10, or an output signal to one or more prepare-to-stop panels of the traffic signaling system 10. Again, other types of an output signal can also be managed and transmitted by the traffic light controller 212, as some other embodiments may dictate.

In contrast, the auxiliary controller 260 can be configured to perform auxiliary tasks comprising, but not limited to, performing a diagnostic test on the traffic light controller 212, collecting data relative to the traffic light controller 212, displaying data on a monitor housed within the housing 202 of the electrical cabinet 200, receiving data from a remote sensor, communicating data to a remote system, and/or storing data on a memory of the auxiliary controller 260.

More specifically, the auxiliary controller 260 can be configured to perform one or more diagnostic tests based on the input signals, on the output signals, on the traffic light system 10 and/or on other electrical components of the electrical cabinet 200 such as the power supply, the communication ports and the like. These diagnostic tests can be performed at a given frequency, or upon demand. In the event that the auxiliary controller 260 has diagnosed one or more electrical components of the electrical cabinet 200 as being damaged or otherwise faulty in any way, the auxiliary controller 260 can communicate alerts, display the alerts, and/or store the alerts in a memory of the auxiliary controller 260.

The auxiliary controller 260 can also be configured to collect data relative to the traffic light controller 212 or relating to positions of vehicles surrounding the road intersection. For instance, the auxiliary controller 260 can monitor data over time, and the monitoring can include monitoring the state of the input devices, monitoring the state of the output devices, monitoring the input signals received from the traffic signaling system 10, monitoring the output signals transmitted to the traffic signaling system 10 and/or any other type of monitoring.

In further embodiments, the auxiliary controller 260 can be configured for displaying data such as the diagnostic data and/or monitored data. In some other embodiments, the auxiliary controller 260 is configured to display ads on road-facing panels, to display weather information on weather condition panels, and to display data of an interface (e.g., a web interface) of a remote system such as the Internet or a smart vehicle interface.

The auxiliary controller 260 can be configured for receiving data from a remote sensor such as sensors of autonomous vehicles, and/or configured for communicating data to a remote system, as needs may dictate.

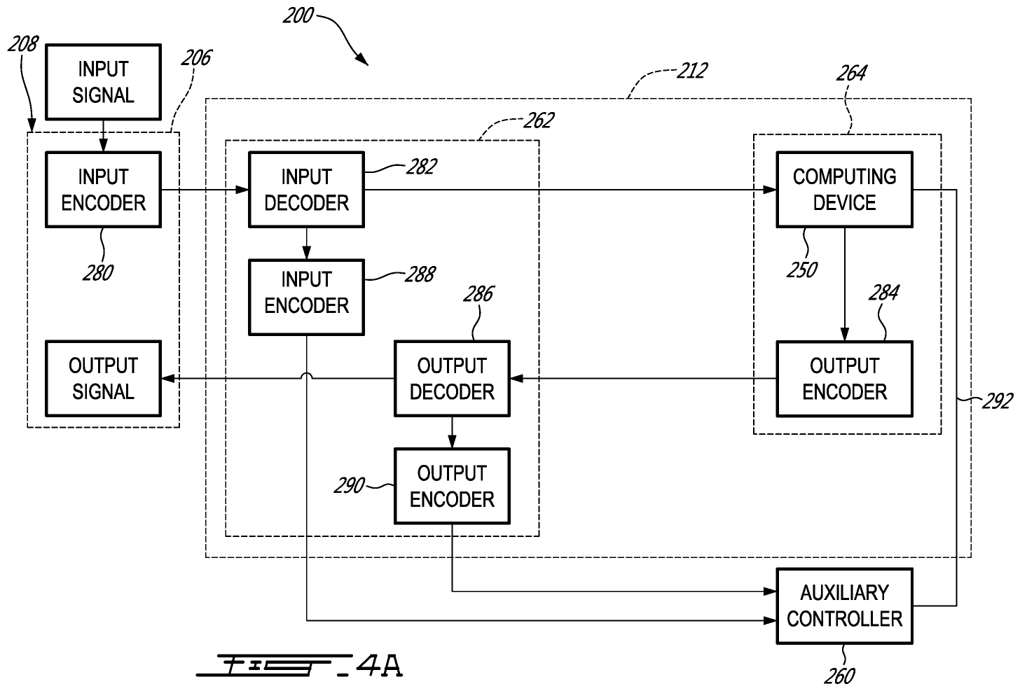

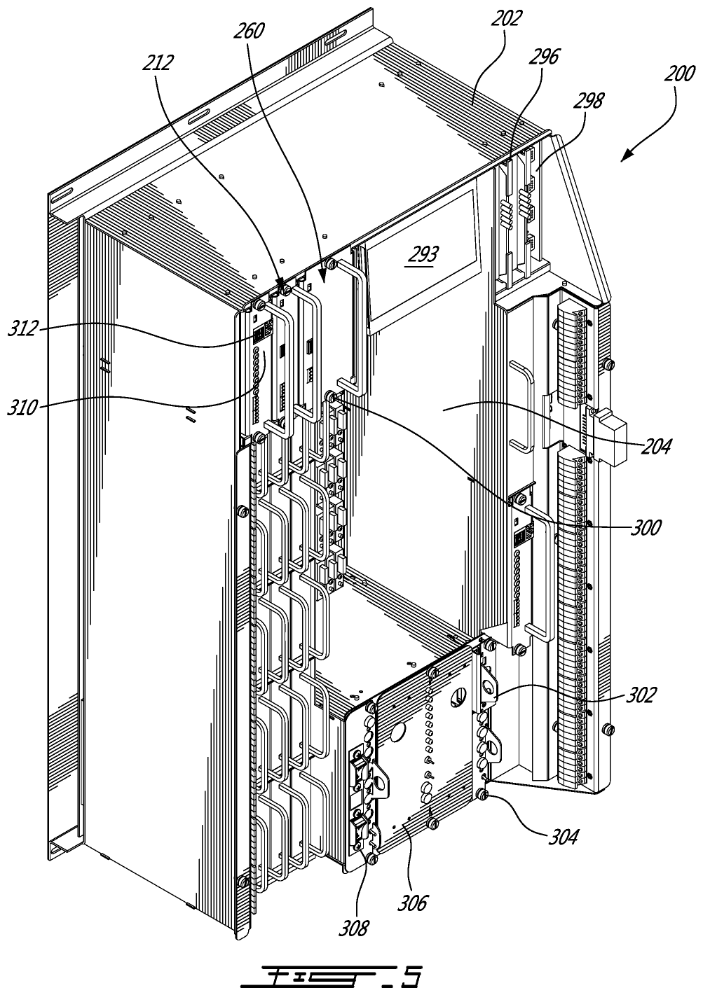

FIG. 4 is an example of the traffic light controller 212, in accordance with an embodiment. As depicted, the traffic light controller 212 has first and second sister circuits 262 and 264 which are connected to one another. The first and second sister circuits 262 and 264 are connected to the electrical interface 206 via edge connectors 214.

As shown in this example, the first and second sister circuits 262 and 264 can be connected to one another via pin header connectors 266. However, in other embodiments, the first and second sister circuits 262 and 264 can be connected to one another via ribbon wires. Other types of connection may appear suitable for the skilled reader.

As mentioned above, the traffic light controller 212 is dedicated to essential tasks pertaining to the control of the traffic signaling system 10. More specifically, in this example, the first sister circuit 262 is configured to receive input signals from the traffic signaling system 10 and to transmit output signals to the traffic signaling system 10. However, the second sister circuit 264 is configured to receive the input signals from the first sister circuit 262, to process them using a computing device, and to transmit the output signals towards the first sister circuit 262, which are then used for controlling the traffic signaling system 10.

In other words, the first sister circuit 262 acts as an interface between the input devices and the output devices of the traffic signaling system 10 whereas the second sister circuit 264 acts as a computing device which processes the inputs signals received from the first sister circuit 262 and transmits the output signals to the first sister circuit 262 to ultimately control said traffic signaling system 10. As such, the first sister circuit 262 can have input interfaces for receiving the input signals from the input devices and output interfaces for transmitting output signals to the output devices of the traffic signaling system 10.

FIG. 4A is a block diagram showing an embodiment in which the input and output signals are serialized through hardware and software for communication within the electrical cabinet 200. As depicted, the electrical interface 206 receives the input signals and transmits the output signals at port 208. It was found that such serial communication can reduce the amount of required signal lines for communicating input and output signals inside the electrical cabinet 200, and thus reduce costs.

Once connected, the input signals incoming from the traffic lighting system 10 are serially encoded with an input encoder 280 and then transmitted towards the first sister circuit 262 of the traffic light controller 212. At the first sister circuit 262, the encoded input signals are decoded using input decoder 282 and then transmitted towards the second sister circuit 264. At the second sister circuit 264, the decoded input signals are processed by a computing device 250 which produces output signals that are then transmitted to an output encoder 284 also lying on the second sister circuit 264 in this example. As briefly mentioned above, the computing device 250 may be similar to the one described with reference to FIG. 2. The output encoder 284 serially encodes the output signals and transmits them to an output decoder 286 of the first sister circuit 262. Once decoded, the output signals may be transmitted to the output devices of the traffic lighting system 10. As illustrated, each output signal transmitted is wired through a dedicated output conductor (e.g., a pin) on the electrical interface 206, to control one or more components of the traffic lighting system 10.

In this specific example, the first sister circuit 262 has an input encoder 288 for serially encoding the input signals received from the input decoder 282 and for transmitting the encoded input signals to the auxiliary controller 260 to perform auxiliary functions such as diagnostic functions. The first sister circuit 262 also has an output encoder 290 for serially encoding the output signals received from the output decoder 286 and for transmitting the encoded output signals to the auxiliary controller 260 for diagnostic purposes, for instance. As shown, the computing device 250 may transmit the output signals directly towards the auxiliary controller via a wired connection 292 in this example.

The skilled reader will understand that the configuration shown and described with reference to FIG. 4A is an example only, as other embodiments may also be used.

Referring back to FIG. 4, the first sister circuit 262 can have a positive direct current voltage (VDC) port, a ground (GND) voltage port, one or more video HDMI output connectors 270, one or more touch screen connectors and can hold the pin header connectors 266 which interface with the second sister circuit 264.

The second sister circuit 264 can have an off/on switch 272, one or more communication ports 274 from which encoded input signals and/or output signals can be transmitted towards the auxiliary controller 260 via the electrical interface 206 and the corresponding edge connectors.

The second sister circuit 264 can also have a set of status indicators 276 mounted to a front plate 278 thereof to show a current status of the traffic light controller 212. The second sister circuit 264 can have one or more HDMI interfaces forwarded through the pin header connector to the first sister circuit 262.

The second sister circuit 264 can incorporate a pluggable GPS module with antenna connector mounted onto the front panel 278 in some embodiments. The second sister circuit 264 can have a port selector configured to allow redirection of its first communication port (i.e., the C2 port) to either a first modem location, a USD/DB9 front panel connector, a LAN Ethernet RJ45 front connector or through the electrical interface 206 via the corresponding edge connectors towards the auxiliary controller 260.

A USB connector or otherwise any data connector can be incorporated in the front panel 278 to locally upgrade and push/pull bios to/from the computing device 250 of the second sister board 264 or from a remote device. A communication link such as a RS485 link can also be routed through the edge connector to carry diagnostic information toward the auxiliary controller 260.

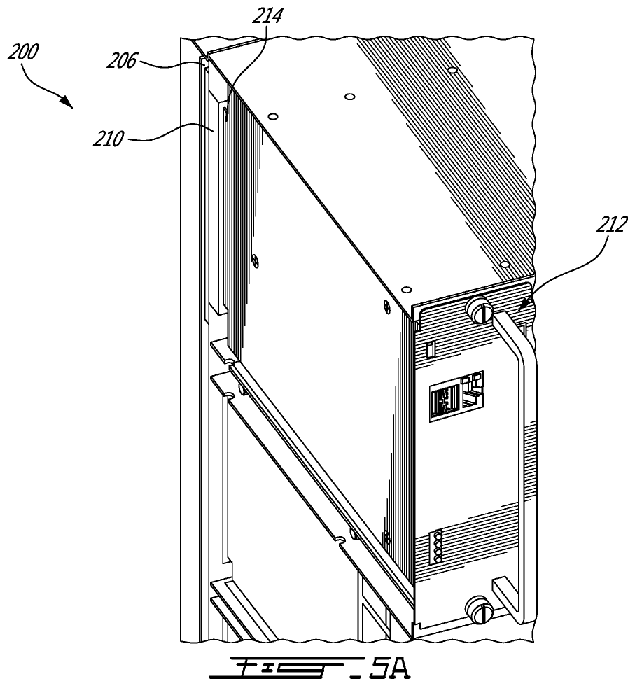

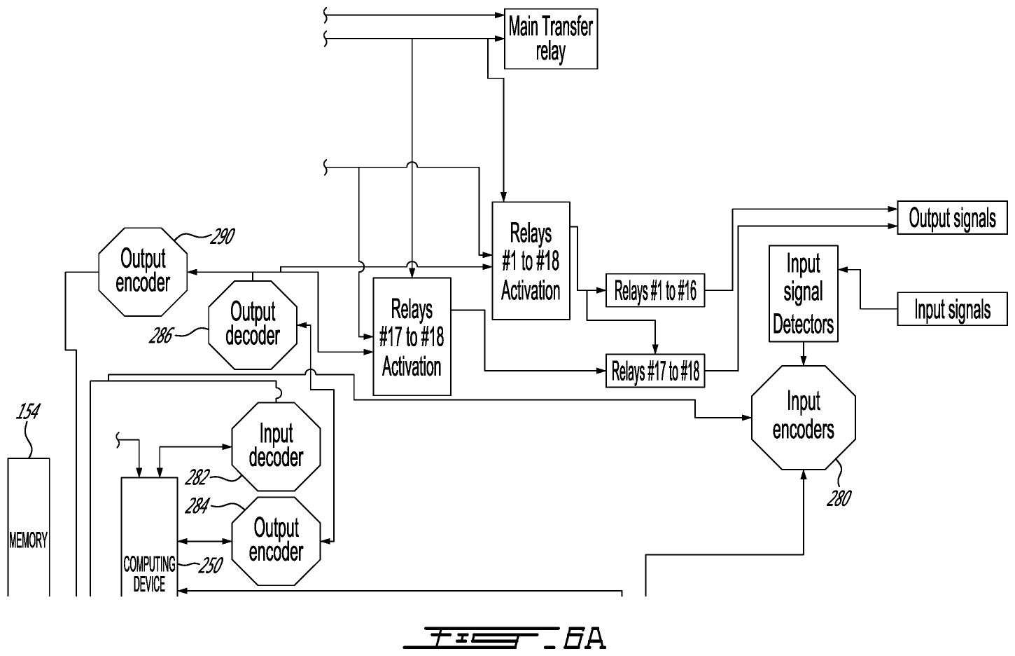

FIG. 5 shows an oblique view of the electrical cabinet 200 for the traffic signaling system 10, in accordance with an embodiment. As described above, the electrical cabinet 200 has the traffic light controller 212 which is connectively received in the electrical interface 206 via corresponding edge connectors. FIG. 5A shows an enlarged view of FIG. 5 which shows the traffic light controller 212 being connected to the electrical interface 206 via the pair of corresponding edge connectors 210 and 214.

Referring back to FIG. 5, the electrical cabinet 200 has a graphical user interface 293 which is connected to the electrical interface via corresponding edge connectors. The electrical cabinet 200 has a first communication port 296 (e.g., a C2 port) and a second communication port 298 (e.g., a C2 port) which are connected to the electrical interface via corresponding edge connectors. The electrical cabinet 200 has an Ethernet port 300, a diagnostic module 302, blinkers 304, a current converter 306, a current distribution circuit 308, a WAN port 310 and a DC voltage converter 312 all being housed within the housing 302, and connected to the electrical interface during use.

The auxiliary controller 260 is also connectively received in the electrical interface via corresponding edge connectors. In this example, the auxiliary controller 260 has a front panel with a LAN Ethernet port, a USB connector or other data connector to upgrade bios if necessary, communication means for communicating with the traffic light controller and the other electrical components of the electrical cabinet via the electrical interface as discussed above. The auxiliary controller will receive the status of the input and output devices via dedicated input and output decoders, and may receive the input and output signals via wired connection such as a RS485 link. This wired connection can also be used by the auxiliary controller to perform diagnostic functions on the traffic light controller. Other wired connections may be used to perform diagnostic functions on other electrical components of the electrical cabinet 200 should they be configured to do so. A communication port may be provided to the auxiliary controller 260 to communicate with the first and second communication ports 296 and 298. Another communication port may be provided to the auxiliary controller 260 to communicate with a memory for storing information. A hard coded memory media can be used to collect data and keep this data safe in case of power failure, for instance.

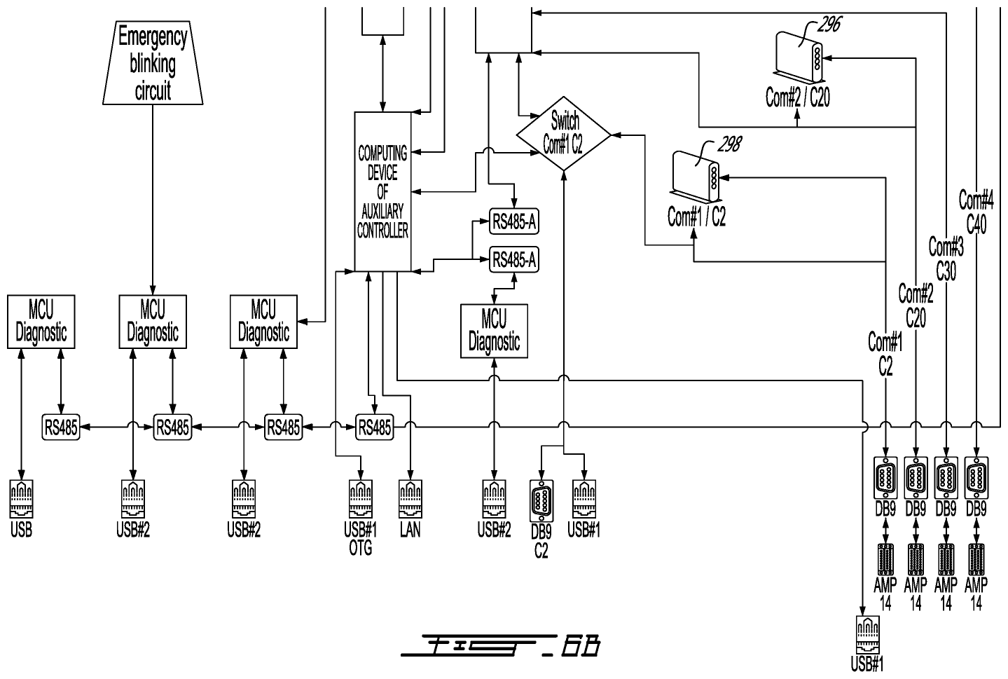

FIGS. 6A-B show a schematic diagram of the electrical cabinet 200. As shown in FIG. 6A, input and output signals are serialized through hardware and software components for communication within the electrical cabinet 200.

As can be understood, the examples described above and illustrated are intended to be exemplary only. The scope is indicated by the appended claims.

What is claimed is:

1. An electrical cabinet for a traffic signaling system, the electrical cabinet comprising: a housing defining a cavity; an electrical interface in said cavity, the electrical interface having a port being connectable to the traffic signaling system and having an edge connector being connected to said port; and a traffic light controller having a corresponding edge connector being connectively received in said edge connector of said electrical interface and being maintained in position therein once received, said traffic light controller being configured for controlling the traffic signaling system via said electrical interface, said controlling including receiving, via said port, a plurality of input signals from the traffic signaling system and transmitting, via said port, a plurality of output signals to the traffic signaling system.

2. The electrical cabinet of claim 1 wherein said edge connector of said traffic light controller is slidably received in said edge connector of said electrical interface.

3. The electrical cabinet of claim 2 wherein said electrical interface has two spaced-apart parallel runners extending perpendicularly from said electrical interface and being adjacent said edge connector of said electrical interface, the traffic light controller being provided in the form of a plug-in drawer being slidably received between said runners.

4. The electrical cabinet of claim 1 wherein the electrical interface has a plurality of input conductors and a plurality of output conductors extending between said port and said edge connector of said electrical interface.

5. The electrical cabinet of claim 4 wherein said input conductors and said output conductors extend at least partially within a panel body of said electrical interface.

6. The electrical cabinet of claim 1 wherein said housing has an opening for sealingly receiving a portion of an input signal cable and a portion of an output signal cable.

7. The electrical cabinet of claim 1 wherein the electrical interface has a plurality of other edge connectors being configured to connectively receive a plurality of other electrical components each having corresponding edge connectors.

8. The electrical cabinet of claim 1 wherein, when in position, said traffic light controller extends parallel to a vertical plane of said electrical cabinet.

9. The electrical cabinet of claim 1 wherein the edge connector of the electrical interface is a female edge connector and the edge connector of the traffic light controller is a male edge connector.

10. The electrical cabinet of claim 9 wherein said male edge connector includes an edge of a printed circuit board and conductive traces leading up to said edge.

11. The electrical cabinet of claim 1 further comprising an auxiliary controller being housed in the cavity and being connected to and computationally independent from said traffic light controller, the auxiliary controller being configured for performing auxiliary functions which do not affect said controlling.

12. The electrical cabinet of claim 11 wherein said auxiliary functions comprise at least a step of a group consisting of:
performing a diagnostic test on said traffic light controller;
collecting data relative to said traffic light controller;
displaying data on a monitor;
communicating data to a remote system; and
storing data on a memory of said auxiliary controller.

13. A method for controlling a traffic signaling system using a traffic light controller via an electrical cabinet, the electrical cabinet having a housing defining a cavity inside which lies an electrical interface, the method comprising:
connecting the traffic signaling system to a port of said electrical interface;
connecting an edge connector of the traffic light controller to a corresponding edge connector of the electrical interface, thereby maintaining said traffic light controller maintained in position once received; and
said traffic light controller controlling said traffic signaling system, said controlling including receiving, via said port, a plurality of input signals from the traffic signaling system and transmitting, via said port, a plurality of output signals to the traffic signaling system.

14. The method of claim 13 wherein said connecting includes slidably connecting said edge connector of said traffic light controller to said edge connector of said electrical interface.

15. The method of claim 13 wherein said connecting includes connecting an edge of said traffic light controller to said edge connector of the electrical interface.

16. The method of claim 13 wherein said electrical interface has an edge connector and said auxiliary controller has a corresponding edge connector, the method further comprising connecting the auxiliary controller to said electrical interface via said edge connectors, said auxiliary controller being configured for performing auxiliary functions which do not affect said controlling of said traffic light controller.

17. The method of claim 16 wherein said auxiliary functions comprise at least a step of a group consisting of:
performing a diagnostic test on said traffic light controller;
collecting data relative to said traffic light controller;
displaying data on a monitor;
communicating data to a remote system; and
storing data on a memory of said auxiliary controller.

18. An electrical cabinet for a traffic signaling system, the electrical cabinet comprising:
a housing defining a cavity;
a traffic light controller being housed in the cavity and being connectable to the traffic signaling system, said traffic light controller being configured for controlling said traffic signaling system, said controlling including receiving a plurality of input signals from the traffic signaling system and transmitting plurality of output signals to the traffic signaling system; and
an auxiliary controller being housed in the cavity and being connected to and computationally independent from said traffic light controller, the auxiliary controller being configured for performing auxiliary functions which do not affect said controlling.

19. The electrical cabinet of claim 18 wherein said receiving comprises at least a step of a group consisting of:
receiving an input signal from one or more sensors of said traffic signaling system;
receiving an input signal from one or more pedestrian buttons of said traffic signaling system; and
receiving an input signal from one or more pre-emption modules in communication with said traffic signaling system.

20. The electrical cabinet of claim 18 wherein said transmitting comprises at least a step of a group consisting of:
transmitting an output signal to one or more traffic lights of said traffic signaling system;
transmitting an output signal to one or more pedestrian crossing lights of said traffic signaling system; and
transmitting an output signal to one or more prepare-to-stop panels of said traffic signaling system.

21. The electrical cabinet of claim 18 wherein said auxiliary functions comprise at least a step of a group consisting of:
performing a diagnostic test on said traffic light controller;
collecting data relative to said traffic light controller;
displaying data on a monitor;
communicating data to a remote system; and
storing data on a memory of said auxiliary controller.

22. The electrical cabinet of claim 18 wherein the traffic light controller includes one or more sister circuits connected to one another.

23. The electrical cabinet of claim 18 wherein said auxiliary controller includes a memory for storing data thereon.

24. The electrical cabinet of claim 18 wherein said traffic light controller and said auxiliary controller are provided in the form of separate printed circuit boards.

25. The electrical cabinet of claim 18 wherein said traffic light controller and said auxiliary controller extend parallel to a vertical plane of said electrical cabinet.

26. The electrical cabinet of claim 18 further comprising an electrical interface via which said traffic light controller and said auxiliary controller are connected to one another.

27. The electrical cabinet of claim 26 wherein said traffic light controller has an edge connector being connectively received in a corresponding edge connector of said electrical interface and being maintained in position therein once received.

28. The electrical cabinet of claim 27 wherein said edge connector of said traffic light controller is slidably received in said edge connector of said electrical interface.

29. A method for operating a traffic signaling system, the method comprising:
controlling said traffic signaling system using a traffic light controller being connected to the traffic signaling system, said controlling including receiving a plurality of input signals from the traffic signaling system and transmitting plurality of output signals to the traffic signaling system; and
performing auxiliary functions pertaining to said traffic signaling system using an auxiliary controller being connected to and computationally independent from said traffic light controller, the auxiliary functions being prevented from affecting said controlling.

30. The method of claim 29 wherein said receiving comprises at least a step of a group consisting of:
receiving an input signal from one or more sensors of said traffic signaling system;
receiving an input signal from one or more pedestrian buttons of said traffic signaling system; and
receiving an input signal from one or more pre-emption modules in communication with said traffic signaling system.

31. The method of claim 29 wherein said transmitting comprises at least a step of a group consisting of:
transmitting an output signal to one or more traffic lights of said traffic signaling system;
transmitting an output signal to one or more pedestrian crossing lights of said traffic signaling system; and
transmitting an output signal to one or more prepare-to-stop panels of said traffic signaling system.

32. The method of claim 29 wherein said auxiliary functions comprise at least a step of a group consisting of:
performing a diagnostic test on said traffic light controller;
collecting data relative to said traffic light controller;
displaying data on a monitor;
communicating data to a remote system; and
storing data on a memory of said auxiliary controller.
